(19) United States
(12) Patent Application Publication
(10) Pub. No.: US 2011/0099476 A1
(43) Pub. Date: Apr. 28, 2011

(54) DECORATING A DISPLAY ENVIRONMENT

(75) Inventors: Gregory N. Snook, Sammamish, WA (US); Relja Markovic, Seattle, WA (US); Stephen G. Latta, Seattle, WA (US); Kevin Geisner, Mercer Island, WA (US); Christopher Vuchetich, Seattle, WA (US); Darren Alexander Bennett, Seattle, WA (US); Arthur Charles Tomlin, Redmond, WA (US); Joel Deaguero, Snohomish, WA (US); Matt Puls, Redmond, WA (US); Matt Coohill, Redmond, WA (US); Ryan Hastings, Seattle, WA (US); Kate Kolesar, Kirkland, WA (US); Brian Scott Murphy, Seattle, WA (US)

(73) Assignee: Microsoft Corporation, Redmond, WA (US)

(21) Appl. No.: 12/604,526

(22) Filed: Oct. 23, 2009

(51) Int. Cl. G06F 3/16; G06F 3/048; G06F 3/033

(52) U.S. Cl. 715/728; 715/863

(57) ABSTRACT

Disclosed herein are systems and methods for decorating a display environment. In one embodiment, a user may decorate a display environment by making one or more gestures, using voice commands, using a suitable interface device, and/or combinations thereof. A voice command can be detected for user selection of an artistic feature, such as, for example, a color, a texture, an object, and a visual effect for decorating in a display environment. The user can also gesture for selecting a portion of the display environment for decoration. Next, the selected portion of the display environment can be altered based on the selected artistic feature. The user's motions can be reflected in the display environment by an avatar. In addition, a virtual canvas or three-dimensional object can be displayed in the display environment for decoration by the user.

### BACKGROUND

Computer users have used various drawing tools for creating art. Commonly, such art is created on a display screen of a computer's audiovisual display by use of a mouse. An artist can generate images by moving a cursor across the display screen and by performing a series of point-and-click actions. In addition, the artist may use a keyboard or the mouse for selecting colors to decorate elements within the generated images. In addition, art applications include various editing tools for adding or changing colors, shapes, and the like.

Systems and methods are needed whereby an artist can use computer input devices other than a mouse and keyboard for creating art. Further, it is desirable to provide systems and methods that increase the degree of a user's perceived interactivity with creation of the art.

### SUMMARY

Disclosed herein are systems and methods for decorating a display environment. In one embodiment, a user may decorate a display environment by making one or more gestures, using voice commands, using a suitable interface device, and/or combinations thereof. A voice command can be detected for user selection of an artistic feature, such as, for example, a color, a texture, an object, and/or a visual effect for decorating in a display environment. For example, the user can speak a desired color choice for coloring an area or portion of a display environment, and the speech can be recognized as selection of the color. Alternatively, the voice command can select one or more of a texture, an object, or a visual effect for decorating the display environment. The user can also gesture for selecting or targeting a portion of the display environment for decoration. For example, the user can make a throwing motion with his or her arm for selecting the portion of the display environment. In this example, the selected portion can be an area on a display screen of an audiovisual device that may be contacted by an object if thrown by the user at the speed and trajectory of the user's throw. Next, the selected portion of the display environment can be altered based on the selected artistic feature. The user's motions can be reflected in the display environment on an avatar. In addition, a virtual canvas or three-dimensional object can be displayed in the display environment for decoration by the user.

In another embodiment, a portion of a display environment may be decorated based on a characteristic of a user's gesture. A user's gesture may be detected by an image capture device. For example, the user's gesture may be a throwing movement, a wrist movement, a torso movement, a hand movement, a leg movement, an arm movement, or the like. A characteristic of the user's gesture may be determined. For example, one or more of a speed, a direction, a starting position, an ending position, and the like associated with the movement may be determined. Based on one or more of these characteristics, a portion of the display environment for decoration may be selected. The selected portion of the display environment may be altered based on the characteristic(s) of the user's gesture. For example, a position of the selected portion in the display environment, a size of the selected portion, and/or a pattern of the selected portion may be based on the speed and/or the direction of a throwing motion of the user.

In yet another embodiment, a captured image of an object can be used in a manner of stenciling for decorating in a display environment. An image of the object may be captured by an image capture device. An edge of at least a portion of the object in the captured image may be determined. A portion of the display environment may be defined based on the determined edge. For example, an outline of an object, such as the user, may be determined. In this example, the defined portion of the display environment can have a shape matching the outline of the user. The defined portion may be decorated, such as, for example, by coloring, by adding texture, and/or by a visual effect.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The systems, methods, and computer readable media for altering a view perspective within a virtual environment in accordance with this specification are further described with reference to the accompanying drawings in which:

FIGS. 1A and 1B illustrate an example embodiment of a configuration of a target recognition, analysis, and tracking system with a user using gestures for controlling an avatar and for interacting with an application;

FIG. 2 illustrates an example embodiment of an image capture device;

FIG. 3 illustrates an example embodiment of a computing environment that may be used to decorate a display environment;

FIG. 4 illustrates another example embodiment of a computing environment used to interpret one or more gestures for decorating a display environment in accordance with the disclosed subject matter;

FIG. 5 depicts a flow diagram of an example method 500 for decorating a display environment;

FIG. 6 depicts a flow diagram of another example method for decorating a display environment;

FIG. 7 is screen display of an example of a defined portion of a display environment having the same shape as an outline of a user in a captured image; and

FIGS. 8-11 are screen displays of other examples of display environments decorated in accordance with the disclosed subject matter.

### DETAILED DESCRIPTION OF ILLUSTRATIVE EMBODIMENTS

As will be described herein, a user may decorate a display environment by making one or more gestures, using voice commands, and/or using a suitable interface device. According to one embodiment, a voice command can be detected for user selection of an artistic feature, such as, for example, a color, a texture, an object, and a visual effect. For example, the user can speak a desired color choice for coloring an area or portion of a display environment, and the speech can be recognized as selection of the color. Alternatively, the voice command can select one or more of a texture, an object, or a visual effect for decorating the display environment. The user can also gesture for selecting a portion of the display environment for decoration. For example, the user can make a throwing motion with his or her arm for selecting the portion of the display environment. In this example, the selected portion can be an area on a display screen of an audiovisual device that may be contacted by an object if thrown by the user at the speed and trajectory of the user's throw. Next, the selected portion of the display environment can be altered based on the selected artistic feature.

In another embodiment, a portion of a display environment may be decorated based on a characteristic of a user's gesture. A user's gesture may be detected by an image capture device. For example, the user's gesture may be a throwing movement, a wrist movement, a torso movement, a hand movement, a leg movement, an arm movement, or the like. A characteristic of the user's gesture may be determined. For example, one or more of a speed, a direction, a starting position, an ending position, and the like associated with the movement may be determined. Based on one or more of these characteristics, a portion of the display environment for decoration may be selected. The selected portion of the display environment may be altered based on the characteristic(s) of the user's gesture. For example, a position of the selected portion in the display environment, a size of the selected portion, and/or a pattern of the selected portion may be based on the speed and/or the direction of a throwing motion of the user.

In yet another embodiment, a captured image of an object can be used in a manner of stenciling for decorating in a display environment. An image of the object may be captured by an image capture device. An edge of at least a portion of the object in the captured image may be determined. A portion of the display environment may be defined based on the determined edge. For example, an outline of an object, such as the user, may be determined. In this example, the defined portion of the display environment can have a shape matching the outline of the user. The defined portion may be decorated, such as, for example, by coloring, by adding texture, and/or by a visual effect.

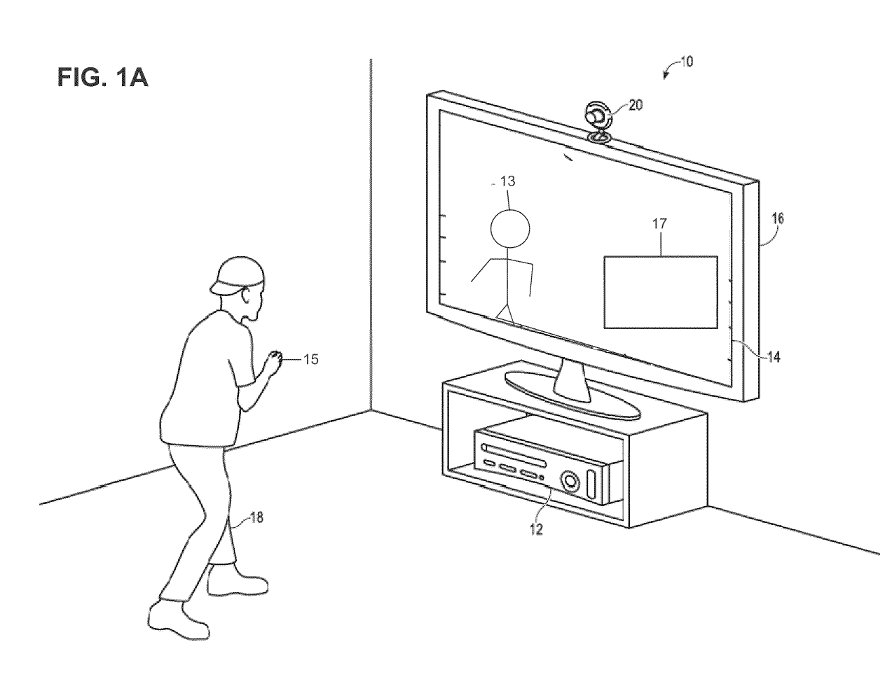

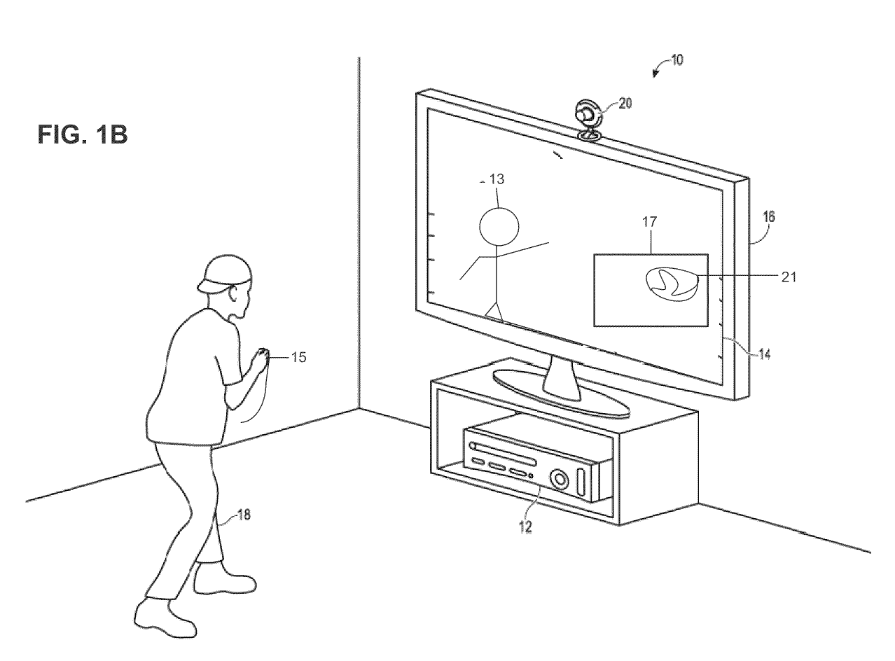

FIGS. 1A and 1B illustrate an example embodiment of a configuration of a target recognition, analysis, and tracking system 10 with a user 18 using gestures for controlling an avatar 13 and for interacting with an application. In the example embodiment, the system 10 may recognize, analyze, and track movements of the user's hand 15 or other appendage of the user 18. Further, the system 10 may analyze the movement of the user 18, and determine an appearance and/or activity for the avatar 13 within a display 14 of an audiovisual device 16 based on the hand movement or other appendage of the user, as described in more detail herein. The system 10 may also analyze the movement of the user's hand 15 or other appendage for decorating a virtual canvas 17, as described in more detail herein.

As shown in FIG. 1A, the system 10 may include a computing environment 12. The computing environment 12 may be a computer, a gaming system, console, or the like. According to an example embodiment, the computing environment 12 may include hardware components and/or software components such that the computing environment 12 may be used to execute applications such as gaming applications, non-gaming applications, and the like.

As shown in FIG. 1A, the system 10 may include an image capture device 20. The capture device 20 may be, for example, a detector that may be used to monitor one or more users, such as the user 18, such that movements performed by the one or more users may be captured, analyzed, and tracked for determining an intended gesture, such as a hand movement for controlling the avatar 13 within an application, as will be described in more detail below. In addition, the movements performed by the one or more users may be captured, analyzed, and tracked for decorating the canvas 17 or another portion of the display 14.

According to one embodiment, the system 10 may be connected to the audiovisual device 16. The audiovisual device 16 may be any type of display system, such as a television, a monitor, a high-definition television (HDTV), or the like that may provide game or application visuals and/or audio to a user such as the user 18. For example, the computing environment 12 may include a video adapter such as a graphics card and/or an audio adapter such as a sound card that may provide audiovisual signals associated with the game application, non-game application, or the like. The audiovisual device 16 may receive the audiovisual signals from the computing environment 12 and may then output the game or application visuals and/or audio associated with the audiovisual signals to the user 18. According to one embodiment, the audiovisual device 16 may be connected to the computing environment 12 via, for example, an S-Video cable, a coaxial cable, an HDMI cable, a DVI cable, a VGA cable, or the like.

As shown in FIG. 1B, in an example embodiment, an application may be executing in the computing environment 12. The application may be represented within the display space of the audiovisual device 16. The user 18 may use gestures to control movement of the avatar 13 and decoration of the canvas 17 within the displayed environment and to control interaction of the avatar 13 with the canvas 17. For example, the user 18 may move his hand 15 in an underhand throwing motion as shown in FIG. 1B for similarly moving a corresponding hand and arm of the avatar 13. Further, the user's throwing motion may cause a portion 21 of the canvas 17 to be altered in accordance with a defined artistic feature. For example, the portion 21 may be colored, altered to have a textured appearance, altered to appear to have been impacted by an object (e.g., putty or other dense substance), altered to include a changing effect (e.g., a three-dimensional effect), or the like. In addition, an animation can be rendered, based on the user's throwing motion, such that the avatar appears to be throwing an object or substance, such as paint, onto the canvas 17. In this example, the result of the animation can be an alteration of the potion 21 of the canvas 17 to include an artistic feature. Thus, according to an example embodiment, the computing environment 12 and the capture device 20 of the system 10 may be used to recognize and analyze a gesture of the user 18 in physical space such that the gesture may be interpreted as a control input of the avatar 13 in the display space for decorating the canvas 17.

In one embodiment, the computing environment 12 may recognize an open and/or closed position of a user's hand for timing the release of paint in the virtual environment. For example, as described above, an avatar can be controlled to “throw” paint onto the canvas 17. The avatar's movement can mimic the throwing motion of the user. During the throwing motion, the release of paint from the avatar's hand to throw the paint onto the canvas can be timed to correspond to when the user opens his or her hand. For example, the user can begin the throwing motion with a closed hand for “holding” paint. In this example, at any time during the user's throwing motion, the user can open his or her hand to control the avatar to release the paint held by the avatar such that it travels towards the canvas. The speed and direction of the paint on release from the avatar's hand can be directly related to the speed and direction of the user's hand speed and direction when the hand is opened. In this way, the throwing of paint by the avatar in the virtual environment can correspond to the user's motion.

In another embodiment, rather than applying paint onto the canvas 17 with a throwing motion or in combination with this motion, a user can move his or her wrist in a flicking motion to apply paint to the canvas. For example, the computing environment 12 can recognize a rapid wrist movement as being a command for applying a small amount of paint onto a portion of the canvas 17. The avatar's movement can reflect the user's wrist movement. In addition, an animation can be rendered in the display environment such that it appears that the avatar is using its wrist to flick paint onto the canvas. The resulting decoration on the canvas can be dependent on the speed and/or direction of motion of the user's wrist movement.

In another embodiment, user movements may be recognized only in a single plane in the user's space. The user may provide a command such that his or her movements are only recognized by the computing environment 12 in an X-Y plane, an X-Z plane, or the like with respect to the user such that the user's motion outside of the plane is ignored. For example, if only movement in the X-Y plane is recognized, movement in the Z-direction is ignored. This feature can be useful for drawing on a canvas by movement of the user's hand. For example, the user can move his or her hand in the X-Y plane, and a line corresponding to the user's movement may be generated on the canvas with a shape that directly corresponds to the user's movement in the X-Y plane. Further, in an alternative, limited movement may be recognized in other planes for effecting alterations as described herein.

System 10 may include a microphone or other suitable device to detect voice commands from a user for use in selecting an artistic feature for decorating the canvas 17. For example, a plurality of artistic features may each be defined, stored in the computing environment 12, and associated with voice recognition data for its selection. A color and/or graphics of a cursor 13 may change based on the audio input. In an example, a user's voice command can change a mode of applying decorations to the canvas 17. The user may speak the word “red,” and this word can be interpreted by the computing environment 12 as being a command to enter a mode for painting the canvas 17 with the color red. Once in the mode for painting with a particular color, a user may then make one or more gestures for “throwing” paint with his or her hand(s) onto the canvas 17. The avatar's movement can mimic the user's motion, and an animation can be rendered such that it appears that the avatar is throwing the paint onto the canvas 17.

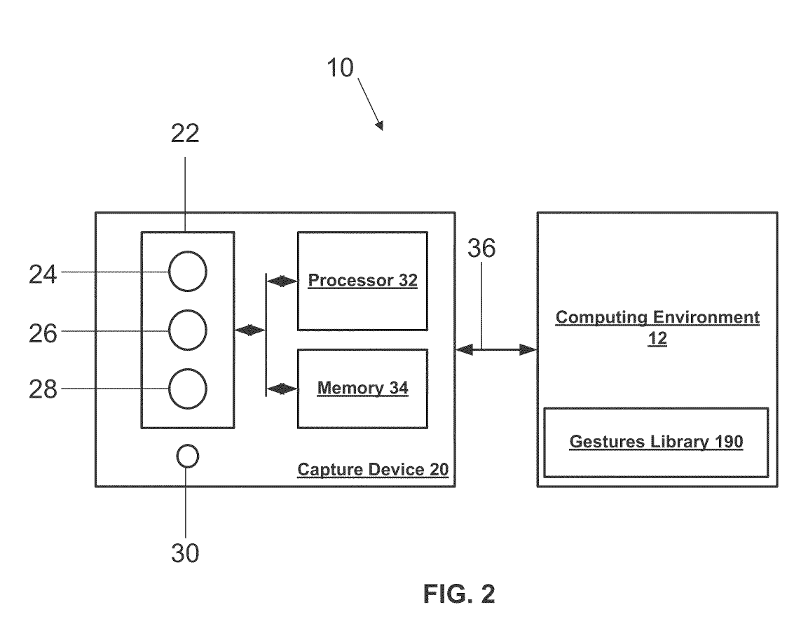

FIG. 2 illustrates an example embodiment of the image capture device 20 that may be used in the system 10. According to the example embodiment, the capture device 20 may be configured to capture video with user movement information including one or more images that may include gesture values via any suitable technique including, for example, time-of-flight, structured light, stereo image, or the like. According to one embodiment, the capture device 20 may organize the calculated gesture information into coordinate information, such as Cartesian and/or polar coordinates. The coordinates of a user model, as described herein, may be monitored over time to determine a movement of the user's hand or the other appendages. Based on the movement of the user model coordinates, the computing environment may determine whether the user is making a defined gesture for decorating a canvas (or other portion of a display environment) and/or for controlling an avatar.

As shown in FIG. 2, according to an example embodiment, the image camera component 22 may include an light component 24, a three-dimensional (3-D) camera 26, and an RGB camera 28 that may be used to capture a gesture image(s) of a user. For example, the IR light component 24 of the capture device 20 may emit an infrared light onto the scene and may then use sensors (not shown) to detect the backscattered infrared and/or visible light from the surface of user's hand or other appendage using, for example, the 3-D camera 26 and/or the RGB camera 28. In some embodiments, pulsed infrared light may be used such that the time between an outgoing light pulse and a corresponding incoming light pulse may be measured and used to determine a physical distance from the capture device 20 to a particular location on the user's hand. Additionally, in other example embodiments, the phase of the outgoing light wave may be compared to the phase of the incoming light wave to determine a phase shift. The phase shift may then be used to determine a physical distance from the capture device to the user's hand. This information may also be used to determine the user's hand movement and/or other user movement for decorating a canvas (or other portion of a display environment) and/or for controlling an avatar.

According to another example embodiment, a 3-D camera may be used to indirectly determine a physical distance from the image capture device 20 to the user's hand by analyzing the intensity of the reflected beam of light over time via various techniques including, for example, shuttered light pulse imaging. This information may also be used to determine movement of the user's hand and/or other user movement.

In another example embodiment, the image capture device 20 may use a structured light to capture gesture information. In such an analysis, patterned light (i.e., light displayed as a known pattern such as grid pattern or a stripe pattern) may be projected onto the scene via, for example, the IR light component 24. Upon striking the surface of the user's hand, the pattern may become deformed in response. Such a deformation of the pattern may be captured by, for example, the 3-D camera 26 and/or the RGB camera 28 and may then be analyzed to determine a physical distance from the capture device to the user's hand and/or other body part.

According to another embodiment, the capture device 20 may include two or more physically separated cameras that may view a scene from different angles, to obtain visual stereo data that may be resolved to generate gesture information.

The capture device 20 may further include a microphone 30. The microphone 30 may include transducers or sensors that may receive and convert sound into electrical signals. According to one embodiment, the microphone 30 may be used to reduce feedback between the capture device 20 and the computing environment 12 in the system 10. Additionally, the microphone 30 may be used to receive audio signals that may also be provided by the user to control the activity and/or appearance of an avatar, and/or a mode for decorating a canvas or other portion of a display environment.

In an example embodiment, the capture device 20 may further include a processor 32 that may be in operative communication with the image camera component 22. The processor 32 may include a standardized processor, a specialized processor, a microprocessor, or the like that may execute instructions that may include instructions for receiving the user gesture-related images, determining whether a user's hand or other body part may be included in the gesture image(s), converting the image into a skeletal representation or model of the user's hand or other body part, or any other suitable instruction.

The capture device 20 may further include a memory component 34 that may store the instructions that may be executed by the processor 32, images or frames of images captured by the 3-D camera or RGB camera, any other suitable information, images, or the like. According to an example embodiment, the memory component 34 may include random access memory (RAM), read only memory (ROM), cache, flash memory, a hard disk, or any other suitable storage component. As shown in FIG. 2, in one embodiment, the memory component 34 may be a separate component in communication with the image capture component 22 and the processor 32. According to another embodiment, the memory component 34 may be integrated into the processor 32 and/or the image capture component 22.

As shown in FIG. 2, the capture device 20 may be in communication with the computing environment 12 via a communication link 36. The communication link 36 may be a wired connection including, for example, a USB connection, a Firewire connection, an Ethernet cable connection, or the like and/or a wireless connection such as a wireless 802.11b, g, a, or n connection. According to one embodiment, the computing environment 12 may provide a clock to the capture device 20 that may be used to determine when to capture a scene via the communication link 36.

Additionally, the capture device 20 may provide the user gesture information and images captured by, for example, the 3-D camera 26 and/or the RGB camera 28, and a skeletal model that may be generated by the capture device 20 to the computing environment 12 via the communication link 36. The computing environment 12 may then use the skeletal model, gesture information, and captured images to, for example, control an avatar's appearance and/or activity. For example, as shown, in FIG. 2, the computing environment 12 may include a gestures library 190 for storing gesture data. The gesture data may include a collection of gesture filters, each comprising information concerning a gesture that may be performed by the skeletal model (as the user's hand or other body part moves). The data captured by the cameras and device 20 in the form of the skeletal model and movements associated with it may be compared to the gesture filters in the gesture library 190 to identify when a user's hand or other body part (as represented by the skeletal model) has performed one or more gestures. Those gestures may be associated with various inputs for controlling an appearance and/or activity of the avatar and/or animations for decorating a canvas. Thus, the computing environment 12 may use the gestures library 190 to interpret movements of the skeletal model and to change the avatar's appearance and/or activity, and/or animations for decorating the canvas.

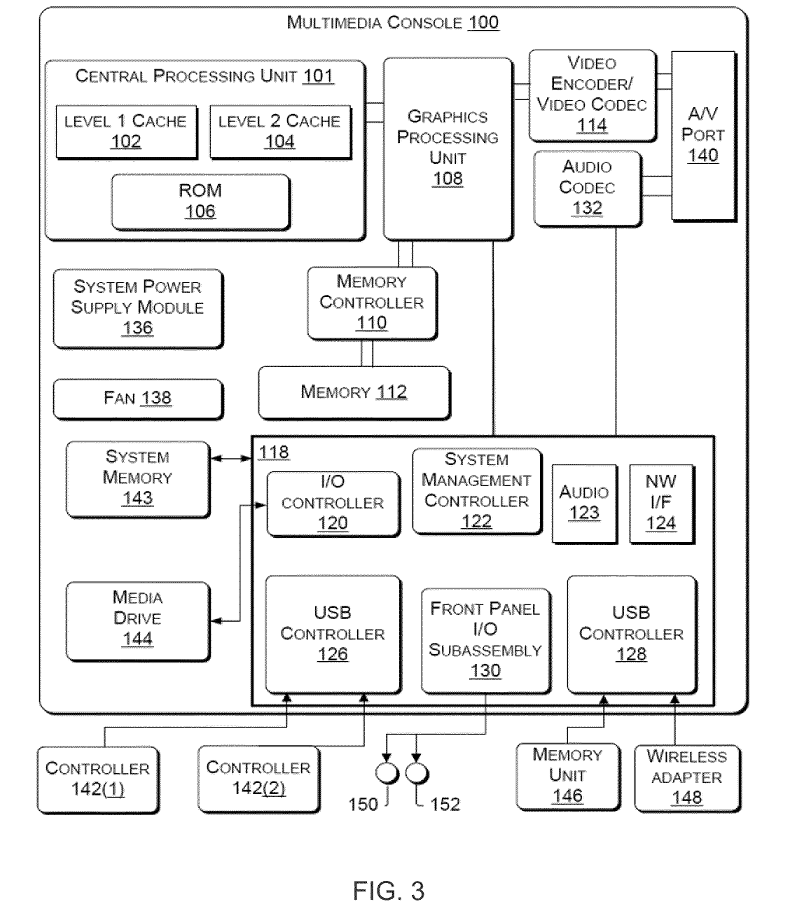

FIG. 3 illustrates an example embodiment of a computing environment that may be used to decorate a display environment in accordance with the disclosed subject matter. The computing environment such as the computing environment 12 described above with respect to FIGS. 1A-2 may be a multimedia console 100, such as a gaming console. As shown in FIG. 3, the multimedia console 100 has a central processing unit (CPU) 101 having a level 1 cache 102, a level 2 cache 104, and a flash ROM (Read Only Memory) 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The flash ROM 106 may store executable code that is loaded during an initial phase of a boot process when the multimedia console 100 is powered ON.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as, but not limited to, a RAM (Random Access Memory). In one example, the GPU 108 may be a widely-parallel general purpose processor (known as a general purpose GPU or GPGPU).

The multimedia console 100 includes an I/O controller 120, a system management controller 122, an audio processing unit 123, a network interface controller 124, a first USB host controller 126, a second USB controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless adapter components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 100 is powered ON, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface 124 or the wireless adapter 148, the multimedia console 100 may further be operated as a participant in a larger network community.

When the multimedia console 100 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., popups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resynch is eliminated.

After the multimedia console 100 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 101 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 142(1) and 142(2)) are shared by gaming applications and system applications. The input devices are not reserved resources, but are to be switched between system applications and the gaming application such that each will have a focus of the device. The application manager preferably controls the switching of input stream, without knowledge the gaming application's knowledge and a driver maintains state information regarding focus switches. The cameras 27, 28 and capture device 20 may define additional input devices for the console 100.

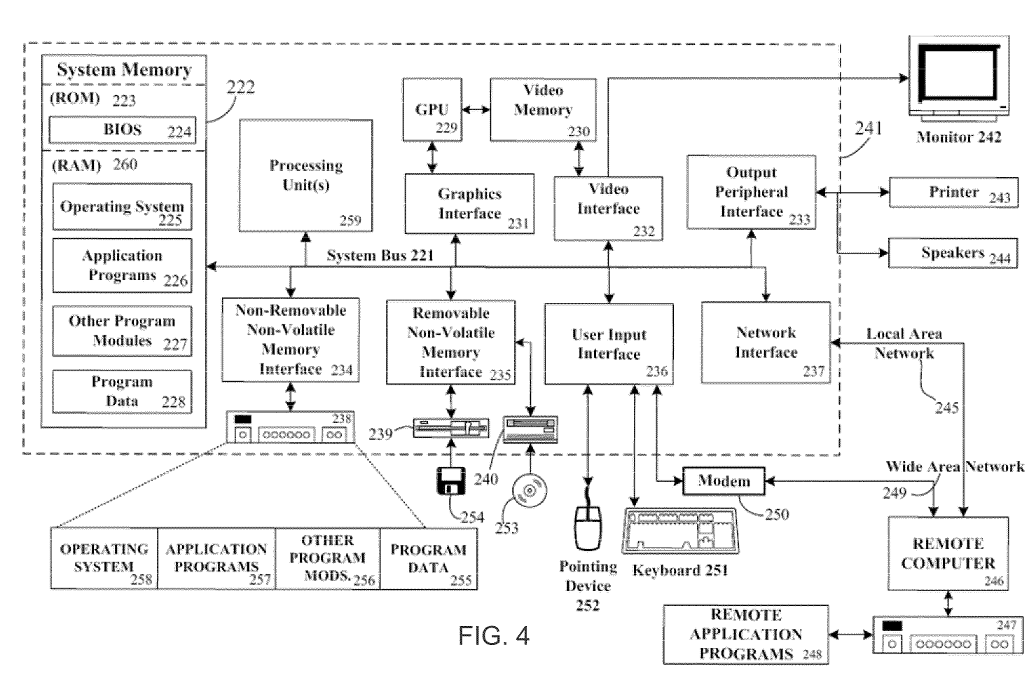

FIG. 4 illustrates another example embodiment of a computing environment 220 that may be the computing environment 12 shown in FIGS. 1A-2 used to interpret one or more gestures for decorating a display environment in accordance with the disclosed subject matter. The computing system environment 220 is only one example of a suitable computing environment and is not intended to suggest any limitation as to the scope of use or functionality of the presently disclosed subject matter. Neither should the computing environment 220 be interpreted as having any dependency or requirement relating to any one or combination of components illustrated in the exemplary operating environment 220. In some embodiments the various depicted computing elements may include circuitry configured to instantiate specific aspects of the present disclosure. For example, the term circuitry used in the disclosure can include specialized hardware components configured to perform function(s) by firmware or switches. In other examples embodiments the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

In FIG. 4, the computing environment 220 comprises a computer 241, which typically includes a variety of computer readable media. Computer readable media can be any available media that can be accessed by computer 241 and includes both volatile and nonvolatile media, removable and non-removable media. The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 4 illustrates operating system 225, application programs 226, other program modules 227, and program data 228.

The computer 241 may also include other removable/non-removable, volatile/nonvolatile computer storage media. By way of example only, FIG. 4 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through a non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 4, provide storage of computer readable instructions, data structures, program modules and other data for the computer 241. In FIG. 4, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). The cameras 27, 28 and capture device 20 may define additional input devices for the console 100. A monitor 242 or other type of display device is also connected to the system bus 221 via an interface, such as a video interface 232. In addition to the monitor, computers may also include other peripheral output devices such as speakers 244 and printer 243, which may be connected through an output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 4. The logical connections depicted in FIG. 2 include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 4 illustrates remote application programs 248 as residing on memory device 247. It will be appreciated that the network connections shown are exemplary and other means of establishing a communications link between the computers may be used.

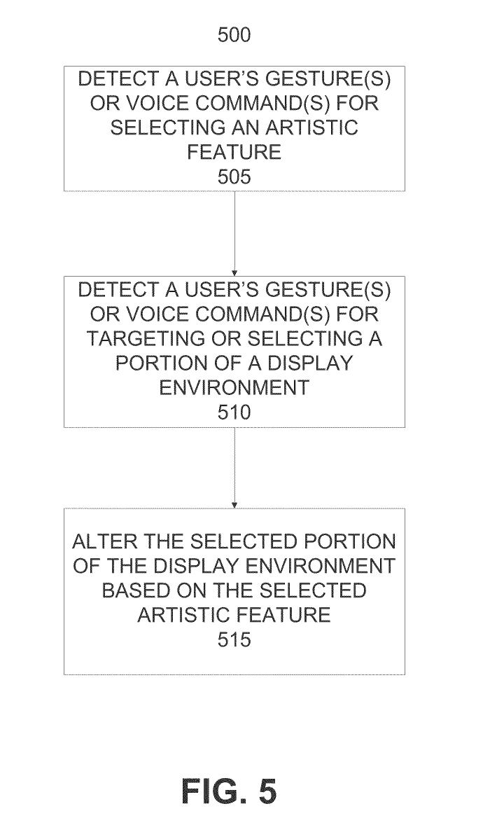

FIG. 5 depicts a flow diagram of an example method 500 for decorating a display environment. Referring to FIG. 5, a user's gestures(s) and/or voice command for selecting an artistic feature is detected at 505. For example, a user may say the word “green” for selecting the color green for decorating in the display environment shown in FIG. 1B. In this example, the application can enter a paint mode for painting with the color green. Alternatively, for example, the application can enter a paint mode if the user names other colors recognized by the computing environment. Other modes for decorating include, for example, a texture mode for adding a texture appearance to the canvas, an object mode for using an object to decorate the canvas, a visual effect mode for adding a visual effect (e.g., a three-dimensional or changing visual effect) to the canvas, and the like. Once a voice command for a mode is recognized, the computing environment can stay in the mode until the user provides input for exiting the mode, or for selecting another mode.

At 510, one or more of the user's gestures and/or the user's voice commands are detected for targeting or selecting a portion of a display environment. For example, an image capture device may capture a series of images of a user while the user makes one or more of the following movements: a throwing movement, a wrist movement, a torso movement, a hand movement, a leg movement, an arm movement, or the like. The detected gestures may be used in selecting a position of the selected portion in the display environment, a size of the selected portion, a pattern of the selected portion, and/or the like. Further, a computing environment may recognize that the combination of the user's positions in the captured images corresponds to a particular movement. In addition, the user's movements may be processed for detecting one or more movement characteristics. For example, the computing environment may determine a speed and/or direction of the arm's movement based on a positioning of an arm in the captured images and the time elapsed between two or more of the images. In another example, based on the captured images, the computing environment may detect a position characteristic of the user's movement in one or more of the captures images. In this example, a user movement's starting position, ending position, intermediate position, and/or the like may be detected for selecting a portion of the display environment for decoration.

In an embodiment, using the one or more detected characteristics of the user's gesture, a portion of the display environment may be selected for decoration in accordance with a selected artistic feature at 505. For example, if a user selects a color mode for coloring red and makes a throwing motion as shown in FIG. 1A, the portion 21 of the canvas 17 is colored red. The computing environment may determine a speed and/or direction of the throwing motion for determining a size of the portion 21, a shape of the portion 21, and a location of the portion 21 in the display environment. Further, the starting position and/or ending position of the throw may be used for determining the size, shape, and/or location of the portion 21.

At 515, the selected portion of the display environment is altered based on the selected artistic feature. For example, the selected portion of the display environment can be colored red or any other color selected by the user using the voice command. In another example, the selected portion may decorated with any other two-dimensional imagery selected by user, such as a striped pattern, a polka dot pattern, any color combination, any color mixture, or the like.

An artistic feature may be any imagery suitable for display within a display environment. For example, two-dimensional imagery may be displayed within a portion of the display environment. In another example, the imagery may appear to be three-dimensional to a viewer. Three-dimensional imagery can appear to have texture and depth to a viewer. In another example, an artistic feature can be an animation feature that changes over time. For example, the imagery can appear organic (e.g., a plant or the like) and grow over time within the selected portion and/or into other portions of the display environment.

In one embodiment, a user can select a virtual object for use in decorating in the display environment. The object can be, for example, putty, paint, or the like for creating a visual effect at a portion of the display environment. For example, after selection of the object, an avatar representing the user can be controlled, as described herein, to throw the object at the portion of the display environment. An animation of the avatar throwing the object can be rendered, and the effect of the object hitting the object can be displayed. For example, a ball of putty thrown at a canvas can flatten on impact with the canvas and render an irregular, three-dimensional shape of the putty. In another example, the avatar can be controlled to throw paint at the canvas. In this example, an animation can show the avatar picking up paint out of a bucket, and throwing the paint at the canvas such that the canvas is painted in a selected color in an irregular, two-dimensional shape.

In an embodiment, the selected artistic feature may be an object that can be sculpted by user gestures or other input. For example, the user may use a voice command or other input for selecting an object that appears three-dimensional in a display environment. In addition, the user may select an object type, such as, for example, clay that can be molded by user gestures. Initially, the object can be spherical in shape, or any other suitable shape for molding. The user can then make gestures that can be interpreted for molding the shape. For example, the user can make a patting gesture for flattening a side of the object. Further, the object can be considered a portion of the display environment that can be decorated by coloring, texturing, a visual effect, or the like, as described herein.

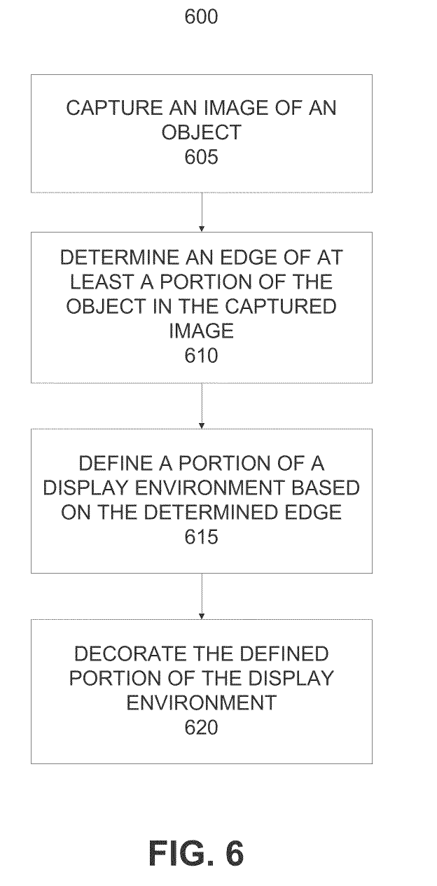

FIG. 6 depicts a flow diagram of another example method 600 for decorating a display environment. Referring to FIG. 6, an image of an object is captured at 605. For example, an image capture device may capture an image of the user or another object. The user can initiate image capture by a voice command or other suitable input.

At 610, an edge of at least a portion of the object in the captured image is determined. The computing environment can be configured to recognize an outline of the user or another object. The outline of the user or object can be stored in the computing environment and/or displayed on a display screen of an audiovisual display. In an example, a portion of an outline of the user or another object can be determined or recognized. In another example, the computing environment can recognize features in the user or object, such as an outline of a user's shirt, or partitions between different portions in an object.

In one embodiment, a plurality of the user's image or another object's image can be captured over a period of time, and an outline of the captured images displayed in the display environment in real time. The user can provide a voice command or other input for storing the displayed outline for display. In this way, the user can be provided with real-time feedback on the current outline prior to capturing the image for storage and display.

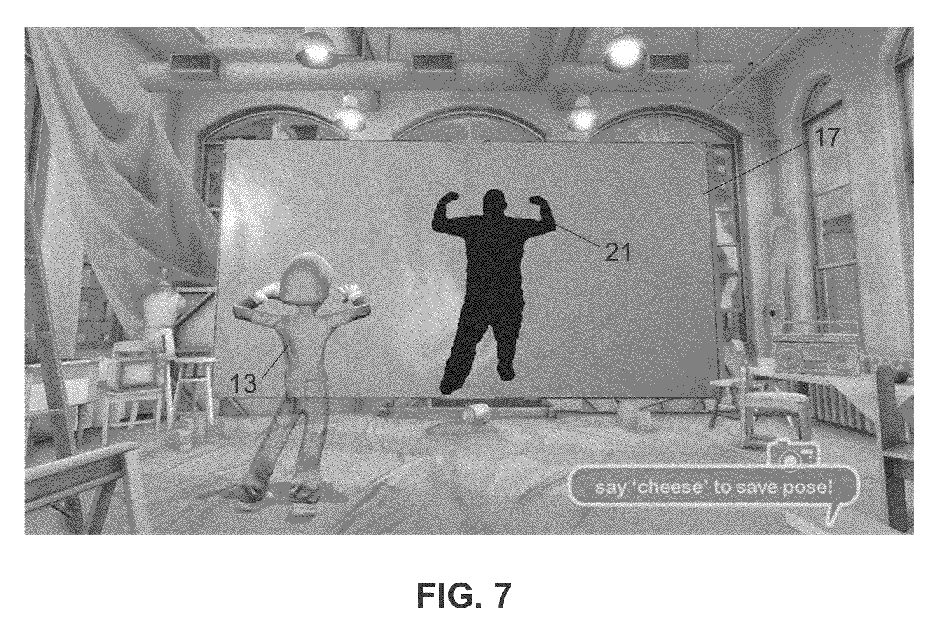

At 615, a portion of a display environment is defined based on the determined edge. For example, a portion of the display environment can be defined to have a shape matching the outline of the user or another object in the captured image. The defined portion of the display environment can then be displayed. For example, FIG. 7 is screen display of an example of a defined portion 21 of a display environment having the same shape as an outline of a user in a captured image. In FIG. 7, the defined portion 21 may be displayed on the virtual canvas 17. Further, as shown in FIG. 7, the avatar 13 is positioned in the foreground in front of the canvas 17. The user can select when to capture his or her image by the voice command “cheese,” which can be interpreted by the computing environment to capture the user's image.

At 620, the defined portion of the display environment is decorated. For example, the defined portion may be decorated in any of the various ways described herein, such as, by coloring, by texturing, by adding a visual effect, or the like. Referring again to FIG. 7, for example, a user may select to color the defined portion 21 in black as shown, or in any other color or pattern of colors. Alternatively, the user may select to decorate the portion of the canvas 17 surrounding the defined portion 21 with an artistic feature in any of the various ways described herein.

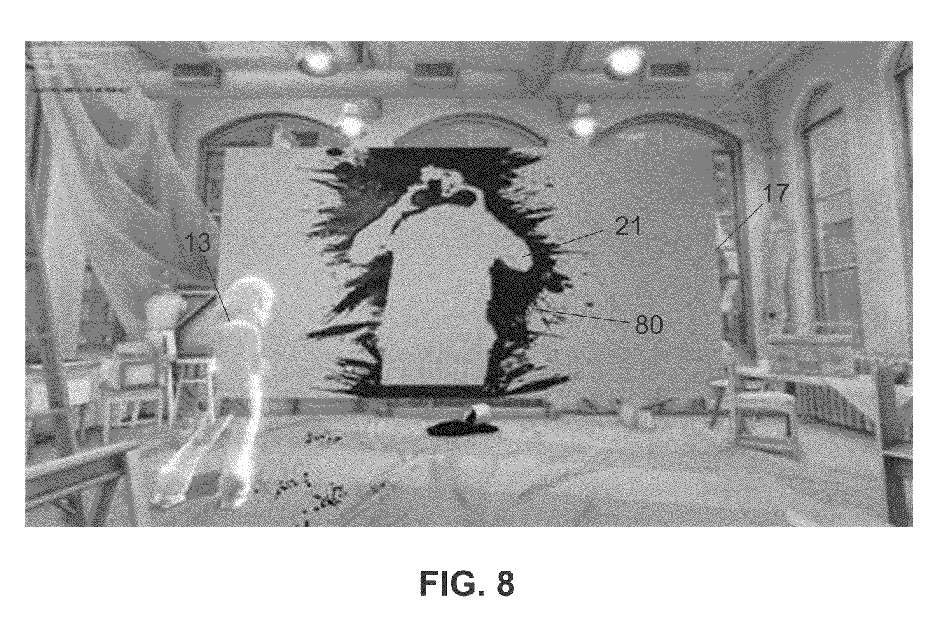

FIGS. 8-11 are screen displays of other examples of display environments decorated in accordance with the disclosed subject matter. Referring to FIG. 8, a decorated portion 80 of the display environment can be generated by the user selecting a color, and making a throwing motion towards the canvas 17. As shown in FIG. 8, the result of the throwing motion is a “splash” effect as if paint has been thrown by the avatar 13 onto the canvas 17. Subsequently, an image of the user is captured for defining a portion 80 that is shaped like an outline of the user. A color of the portion 80 can be selected by the user's voice command for selecting a color.

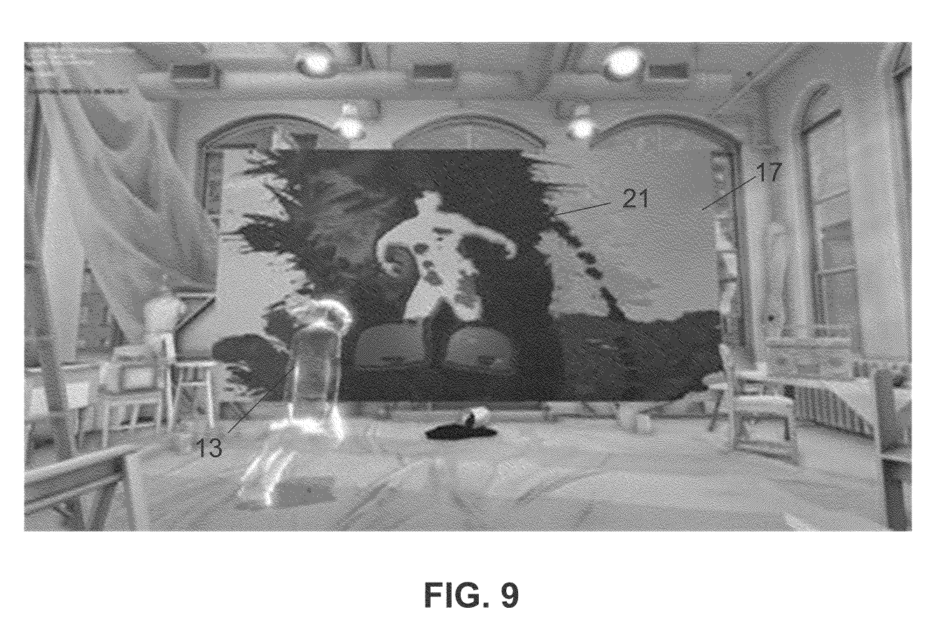

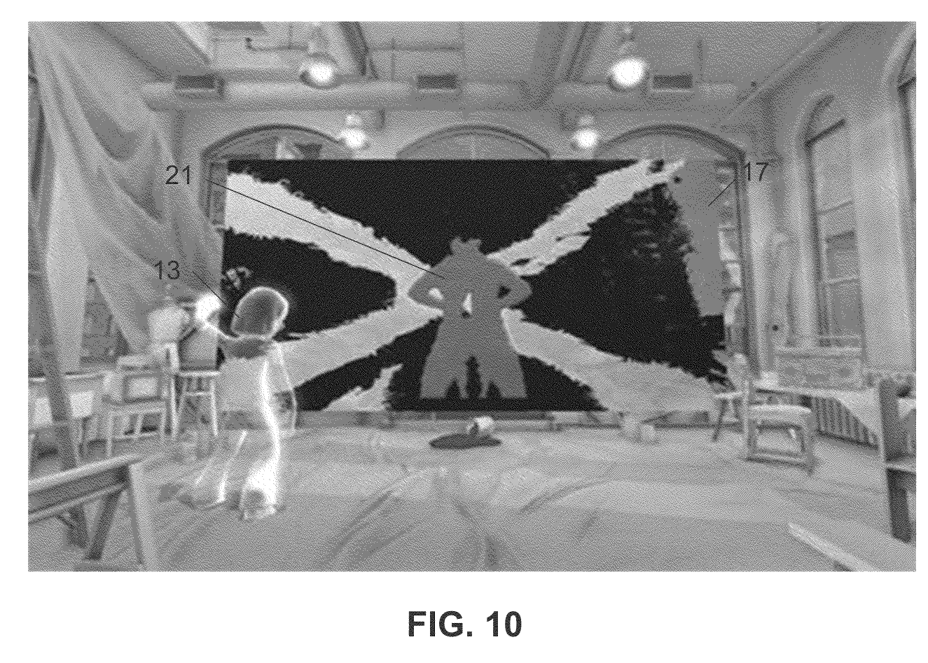

Referring to FIGS. 9 and 10, the portion 21 is defined by a user's outline in a captured image. The defined portion 21 is surrounded by other portions decorated by the user.

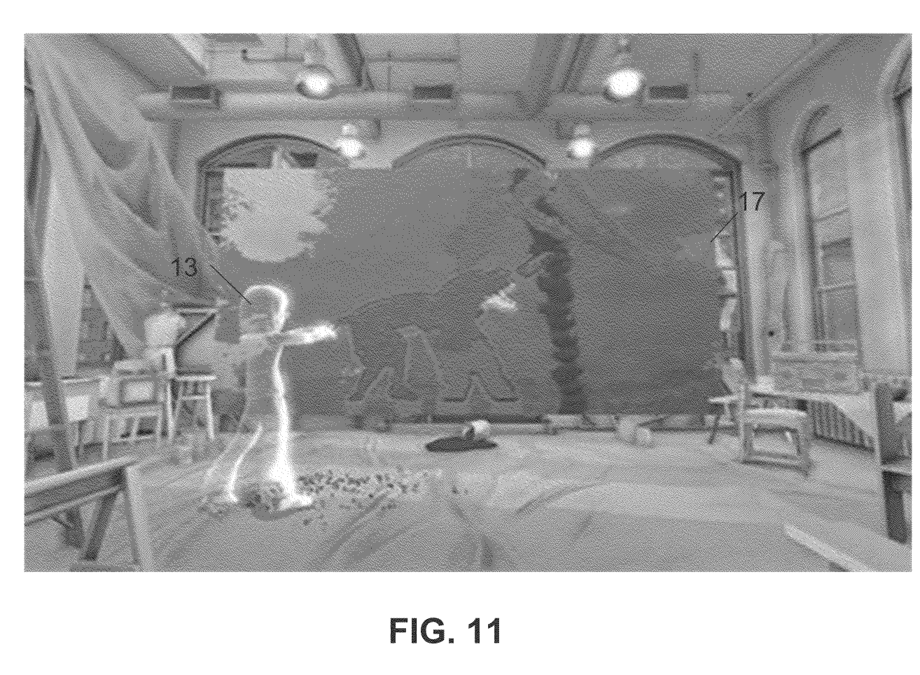

Referring to FIG. 11, the canvas 17 included a plurality of portions decorated by the user as described herein.

In one embodiment, a user may utilize voice commands, gestures, or other inputs for adding and removing components or elements in a display environment. For example, shapes, images, or other artistic features contained in image files may be added to or removed from a canvas. In another example, the computing environment may recognize a user input as being an element in a library, retrieve the element, and display the element in the display environment for alteration and/or placement by the user. In addition, objects, portions, or other elements in the display environment may be identified by voice commands, gestures, or other inputs, and a color or other artistic feature of the identified object, portion, or element may be changed. In another example, a user may select to enter modes for utilizing a paint bucket, a single blotch feature, fine swath, or the like. In this example, selection of the mode effects the type of artistic feature rendered in the display environment when the user makes a recognized gesture.

In one embodiment, gesture controls in the artistic environment can be augmented with voice commands. For example, a user may use a voice command for selecting a section within a canvas. In this example, the user may then use a throwing motion to throw paint, generally in the section selected using the voice command.

In another embodiment, a three-dimensional drawing space can be converted into a three-dimensional and/or two-dimensional image. For example, the canvas 17 shown in FIG. 11 may be converted into a two-dimensional image and saved to a file. Further, a user may pan around a virtual object in the display environment for selecting a side perspective from which to generate a two-dimensional image. For example, a user may sculpt a three-dimensional object as described herein, and the user may select a side of the object from which to generate a two-dimensional image.

In one embodiment, the computing environment may dynamically determine a screen position of a user in the user's space by analyzing one or more of the user's shoulder position, reach, stance, posture, and the like. For example, the user's shoulder position may be coordinated with the plane of a canvas surface displayed in the display environment such that the user's shoulder position in the virtual space of the display environment is parallel to the plane of the canvas surface. The user's hand position relative to the user's shoulder position, stance, and/or screen position may be analyzed for determining whether the user intends to use his or her virtual hand(s) to interact with the canvas surface. For example, if the user reaches forward with his or her hand, the gesture can be interpreted as a command for interacting with the canvas surface for altering a portion of the canvas surface. The avatar can be shown to extend its hand to touch the canvas surface in a movement corresponding to the user's hand movement. Once the avatar's hand touches the canvas surface, the hand can affect elements on the canvas, such as, for example, by moving colors (or paint) appearing on the surface. Further, in the example, the user can move his or her hand to effect a movement of the avatar's hand to smear or mix paint on the canvas surface. The visual effect, in this example, is similar to finger painting in a real environment. In addition, a user can select to use his or her hand in this way move artistic features in display environment. Further, for example, the movement of the user in real space can be translated to the avatar's movement in the virtual space such that the avatar moves around a canvas in the display environment.

In another example, the user can use any portion of the body for interacting with a display environment. Other than use of his or her hand, the user may use feet, knees, head, or other body part for effecting an alteration to a display environment. For example, a user may extend his or her foot, similar to moving a hand, for causing the avatar's knee to touch a canvas surface, and thereby, alter an artistic feature on the canvas surface.

In one embodiment, a user's torso gestures may be recognized by the computing environment for effecting artistic features displayed in the display environment. For example, the user may move his or her body back-and-forth (or in a “wiggle” motion) to effect artistic features. The torso movement can distort an artistic feature, or “swirl” a displayed artistic feature.

In one embodiment, an art assist feature can be provided for analyzing current artistic features in a display environment and for determining user intent with respect to these features. For example, the art assist feature can ensure that there are no empty, or unfilled, portions in the display environment or a portion of the display environment, such as, for example, a canvas surface. Further, the art assist feature can “snap” together portions in the display environment.

In one embodiment, the computing environment maintains an editing toolset for editing decorations or art generated in a display environment. For example, the user may undo or redo input results (e.g., alterations of display environment portions, color changes, and the like) using a voice command, a gesture, or other input. In other examples, a user may layer artistic features in the display environment, zoom, stencil, and/or apply/reject for fine work. Input for using the toolset may be by voice commands, gestures, or other inputs.

In one embodiment, the computing environment may recognize when a user does not intend to create art. In effect, this feature can pause the creation of art in the display environment by the user, so the user can take a break. For example, the user can generate a recognized voice command, gesture, or the like for pausing. The user can resume the creation of art by a recognized voice command, gesture, or the like.

In yet another embodiment, art generated in accordance with the disclosed subject matter may be replicated on real world objects. For example, a two-dimensional image created on the surface of a virtual canvas may be replicated onto a poster, coffee mug, calendar, and the like. Such images may be downloaded from a user's computing environment to a server for replication of a created image onto an object. Further, the images may be replicated on virtual world objects such as an avatar, a display wallpaper, and the like.

It should be understood that the configurations and/or approaches described herein are exemplary in nature, and that these specific embodiments or examples are not to be considered limiting. The specific routines or methods described herein may represent one or more of any number of processing strategies. As such, various acts illustrated may be performed in the sequence illustrated, in other sequences, in parallel, or the like. Likewise, the order of the above-described processes may be changed.

Additionally, the subject matter of the present disclosure includes combinations and subcombinations of the various processes, systems and configurations, and other features, functions, acts, and/or processes disclosed herein, as well as equivalents thereof.

What is claimed:

1. A method for decorating a display environment, the method comprising:
detecting a user's gesture or voice command for selecting an artistic feature;
detecting a user's gesture or voice command for targeting or selecting a portion of a display environment; and
altering the selected portion of the display environment based on the selected artistic feature.

2. The method of claim 1, wherein detecting a user's gesture or voice command for selecting an artistic feature comprises detecting a gesture or voice command for selecting a color, and
wherein altering the selected portion of the display environment comprises coloring the selected portion of the display environment using the selected color.

3. The method of claim 1, wherein detecting a user's gesture or voice command for selecting an artistic feature comprises detecting a gesture or voice command for selecting one of a texture, an object, and a visual effect.

4. The method of claim 1, wherein altering the selected portion of the display environment comprises decorating the selected portion with two-dimensional imagery.

5. The method of claim 1, wherein altering the selected portion of the display environment comprises decorating the selected portion with three-dimensional imagery.

6. The method of claim 1, comprising displaying, at the selected portion, a three-dimensional object, and
wherein altering the selected portion of the display environment comprises altering an appearance of the three-dimensional object based on the selected artistic feature.

7. The method of claim 6, comprising:
receiving another user gesture or voice command; and
altering a shape of the three-dimensional object based on the other user gesture or voice command.

8. The method of claim 1, comprising storing a plurality of gesture data corresponding to a plurality of inputs,
wherein detecting a user's gesture or voice command for targeting or selecting a portion of a display environment comprises detecting a characteristic of at least one of the following user movements: a throwing movement, a wrist movement, a torso movement, a hand movement, a leg movement, and an arm movement; and
wherein altering the selected portion of the environment comprises altering the selected portion of the display environment based on the detected characteristic of the user movement.

9. The method of claim 1, comprising using an image capture device to detect the user's gestures.

10. A method for decorating a display environment, the method comprising:
detecting user's gesture or voice command;
determining a characteristic of the user's gesture or voice command;
selecting a portion of a display environment based on the characteristic of the user's gesture or voice command; and
altering the selected portion of the display environment based on the characteristic of the user's gesture or voice command.

11. The method of claim 10, wherein determining a characteristic of the user's gesture or voice command comprises determining at least one of a speed, a direction, starting position, and ending position associated with the user's arm movement, and
wherein selecting a portion of a display environment comprises selecting a position of the selected portion in the display environment, a size of the selected portion, and a pattern of the selected portion based on the at least one of a speed and a direction associated with the user's arm movement.

12. The method of claim 11, wherein altering the selected portion comprises altering one of a color, a texture, and a visual effect of the selected portion based on the at least one of a speed, a direction, starting position, and ending position associated with the user's arm movement.

13. The method of claim 10, comprising:
displaying an avatar in the display environment;
controlling the displayed avatar to mimic the user's gesture; and
displaying an animation of the avatar altering the selected portion of the display environment based on the characteristic of the user's gesture.

14. The method of claim 10, comprising detecting a user's gesture or voice command for selecting an artistic feature, and
wherein altering the selected portion of the display environment comprises altering the selected portion of the display environment based on the selected artistic feature.

15. The method of claim 14, wherein detecting a user's gesture or voice command comprises detecting a voice command for selecting one of a color, a texture, an object, and a visual effect.

16. A computer readable medium having stored thereon computer executable instructions for decorating a display environment, comprising:
capturing an image of an object;
determining an edge of at least a portion of the object in the captured image;
defining a portion of a display environment based on the determined edge; and
decorating the defined portion of the display environment.

17. The computer readable medium of claim 16, wherein capturing an image of an object comprises capturing an image of a user,
wherein determining an edge comprises determining an outline of the user, and
wherein defining a portion of the display environment comprises defining the portion of the display environment to have a shape matching the outline of the user.

18. The computer readable medium of claim 17, wherein the computer executable instructions for decorating a display environment further comprise:
capturing the user's image over a period of time, wherein the outline of the user changes over the period of time; and
altering the shape of the portion in response to changes to the user's outline.

19. The computer readable medium of claim 16, wherein the computer executable instructions for decorating a display environment further comprise receiving user selection of one of a color, a texture, and a visual effect, and
wherein decorating the defined portion of the display environment comprises decorating the defined portion of the display environment in accordance with the selected one of a color, a texture, and a visual effect.

20. The computer readable medium of claim 16, wherein the computer executable instructions for decorating a display environment further comprise using an image capture device to capture the image of the object.
